(19) United States
(12) Patent Application Publication
(10) Pub. No.: US 2022/0180388 A1
(43) Pub. Date: Jun. 9, 2022

(54) METHODS AND SYSTEMS OF AN AUTOMATED DEALS EVALUATION AND MANAGEMENT PLATFORM

(71) Applicant: sandeep AGGARWAL, GURGAON (IN)

(72) Inventor: sandeep AGGARWAL, GURGAON (IN)

(21) Appl. No.: 17/511,559

(22) Filed: Oct. 27, 2021

Related U.S. Application Data
(63) Continuation-in-part of application No. 17/033,890, filed on Sep. 27, 2020, now abandoned.
Application No. 17/033,890 is a continuation-in-part of application No. 17/065,446, filed on Oct. 7, 2020, now abandoned.
(60) Provisional application No. 62/906,098, filed on Sep. 26, 2019.
(60) Provisional application No. 62/906,099, filed on Sep. 26, 2019.
(60) Provisional application No. 62/911,379, filed on Oct. 7, 2019.
(60) Provisional application No. 62/911,377, filed on Oct. 7, 2019.

(51) Int. Cl. G06Q 30/02

(52) U.S. Cl. CPC G06Q 30/0222; G06Q 30/0206

(57) ABSTRACT

A method for implementing a implementing an automated deals evaluation and management platform comprising: determining that a seller submits a deal with details of the vehicle, buyer and price; determining that the submitted deal is communicated into an automatic system verification process to satisfy a specified set of qualifications; determining that the deals are accepted or rejected by the automated deals evaluation and management platform based on satisfying the eligibility criteria defined under the respective profiles; once the maximum discount is defined by the automated deals evaluation and management platform using a pricing engine, determining with the pricing engine the discount base on the following line items; based on the verification type chosen by the seller during deal submission, performing a due verification and passing the verified deals with a financial operations team; implementing a coupon verification; and generating a coupon generated and tagging the coupon to a buyer email and a vehicle listing on which the deal was submitted and the seller of the listing.

### CLAIM OF PRIORITY

This application claim priority to and is a continuation in party of U.S. patent application Ser. No. 17/033,890, filed on Sep. 27, 2020, and titled METHODS AND SYSTEMS FOR CREDIT RISK ASSESSMENT FOR USED VEHICLE FINANCING. U.S. patent application Ser. No. 17/033,890 claims priority to U.S. Provisional Patent Application No. 62/906,098, filed on Sep. 26, 2019, and titled CREDIT RISK ASSESSMENT FOR USED VEHICLE FINANCING. U.S. patent application Ser. No. 17/033,890 claims priority to U.S. Provisional Patent Application No. 62/906,099, filed on Sep. 26, 2019, and titled AUTOMATED DEALS EVALUATION AND MANAGEMENT PLATFORM. These applications are hereby incorporate by reference in their entirety.

This application claim priority to and is a continuation in party of U.S. patent application Ser. No. 17/065,446, filed on Oct. 7, 2020, and titled METHODS AND SYSTEMS FOR CREDIT RISK ASSESSMENT FOR USED VEHICLE FINANCING. U.S. patent application Ser. No. 17/065,446 claims priority to U.S. Provisional Patent Application No. 62/911,379, filed on Oct. 7, 2019, and titled METHODS AND SYSTEMS OF IMPLEMENTING A TOKEN TRANSFER FEATURE. U.S. patent application Ser. No. 17/065,446 claims priority to U.S. Provisional Patent Application No. 62/911,377, filed on Oct. 7, 2019, and titled METHODS AND SYSTEMS FOR RATING NEW VEHICLES IN AN ONLINE VEHICLE SALES PLATFORM. These applications are hereby incorporate by reference in their entirety.

### BACKGROUND

Generally, when someone wishes to purchase a used vehicle (e.g. an automobile, etc.), the user can seek the lowest price. Additionally, when selling a used vehicle, the user can seek the highest price possible. It is also a common scenario that when someone is buying a used automobile from an individual seller, the buyer can acquire the used vehicle at a much lower price than buying from an automobile dealer considering the profit margin of the dealer in the transitional transaction. Similarly, when a user is selling a used vehicle, the used vehicle can fetch a better value when the sale is made to an individual buyer than an automobile dealer as the automobile dealer would try and acquire the vehicle at a lower price and add his/her profit margin during the transitional sale. However, individual users may not have the information to maximize their quoted prices to offer their used vehicle at. Additionally, a buying non-professional user may not have sufficient information to determine a reasonable price to purchase a used vehicle.

### SUMMARY OF THE INVENTION

A method for implementing a implementing an automated deals evaluation and management platform comprising: determining that a seller submits a deal with details of the vehicle, buyer and price; determining that the submitted deal is communicated into an automatic system verification process to satisfy a specified set of qualifications; determining that the deals are accepted or rejected by the automated deals evaluation and management platform based on satisfying the eligibility criteria defined under the respective profiles; once the maximum discount is defined by the automated deals evaluation and management platform using a pricing engine, determining with the pricing engine the discount base on the following line items; based on the verification type chosen by the seller during deal submission, performing a due verification and passing the verified deals with a financial operations team; implementing a coupon verification; and generating a coupon generated and tagging the coupon to a buyer email and a vehicle listing on which the deal was submitted and the seller of the listing.

### BRIEF DESCRIPTION OF THE DRAWINGS

FIG. 1 illustrates an example process for implementing an automated deals evaluation and management platform, according to some embodiments.

FIG. 2 illustrates an example process for satisfying a specified set of qualifications, according to some embodiments.

FIG. 3 illustrates an example table for implementing baseline pricing, according to some embodiments.

FIG. 4 illustrates an example process for implementing an automated deals evaluation and management platform, according to some embodiments.

FIG. 5 illustrates an example rules process, according to some embodiments.

This is the logic for round down is provided in FIG. 6, according to some embodiments.

FIG. 7 illustrates an example table for the qualified deal is now subjected to the first SPCMP engine, which assigns a base coupon value to the deal, according to some embodiments.

FIG. 8 illustrates the case, as per the engine, the maximum value for the coupon, according to some embodiments.

FIG. 9 is a block diagram of a sample computing environment that can be utilized to implement various embodiments.

The Figures described above are a representative set and are not an exhaustive with respect to embodying the invention.

### DESCRIPTION

Disclosed are a system, method, and article of manufacture of an automated deals evaluation and management platform. The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to ‘one embodiment,’ ‘an embodiment,’ ‘one example,’ or similar language means that a particular feature, structure, or characteristic described in connection with the embodiment is included in at least one embodiment, according to some embodiments. Thus, appearances of the phrases ‘in one embodiment,’ ‘in an embodiment,’ and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### Definitions

Example definitions for some embodiments are now provided.

Machine learning is a type of artificial intelligence (AI) that provides computers with the ability to learn without being explicitly programmed. Machine learning focuses on the development of computer programs that can teach themselves to grow and change when exposed to new data. Example machine learning techniques that can be used herein include, inter alio: decision tree learning, association rule learning, artificial neural networks, inductive logic programming, support vector machines, clustering, Bayesian networks, reinforcement learning, representation learning, similarity and metric learning, and/or sparse dictionary learning. Random forests (RF) (e.g. random decision forests) are an ensemble learning method for classification, regression and other tasks, that operate by constructing a multitude of decision trees at training time and outputting the class that is the mode of the classes (e.g. classification) or mean prediction (e.g. regression) of the individual trees. RFs can correct for decision trees' habit of overfitting to their training set. Deep learning is a family of machine learning methods based on learning data representations. Learning can be supervised, semi-supervised or unsupervised.

Terms and conditions (T&C) are the legal agreements between a service provider and a person who wants to use that service. The party must agree to abide by the terms of service in order to use the offered service.

Weighted average is the average of values which are scaled by importance. The weighted average of values is the sum of weights times values divided by the sum of the weights.

### Example Methods and Systems

Disclosed is a customer acquisition channel by which discounts and coupons can be auto created using a set of rule based synchronized engines. The rule based synchronized engines can help a model seller adopt a sales platform, deliver model behavior for the marketplace and create a delightful experience for buyer(s).

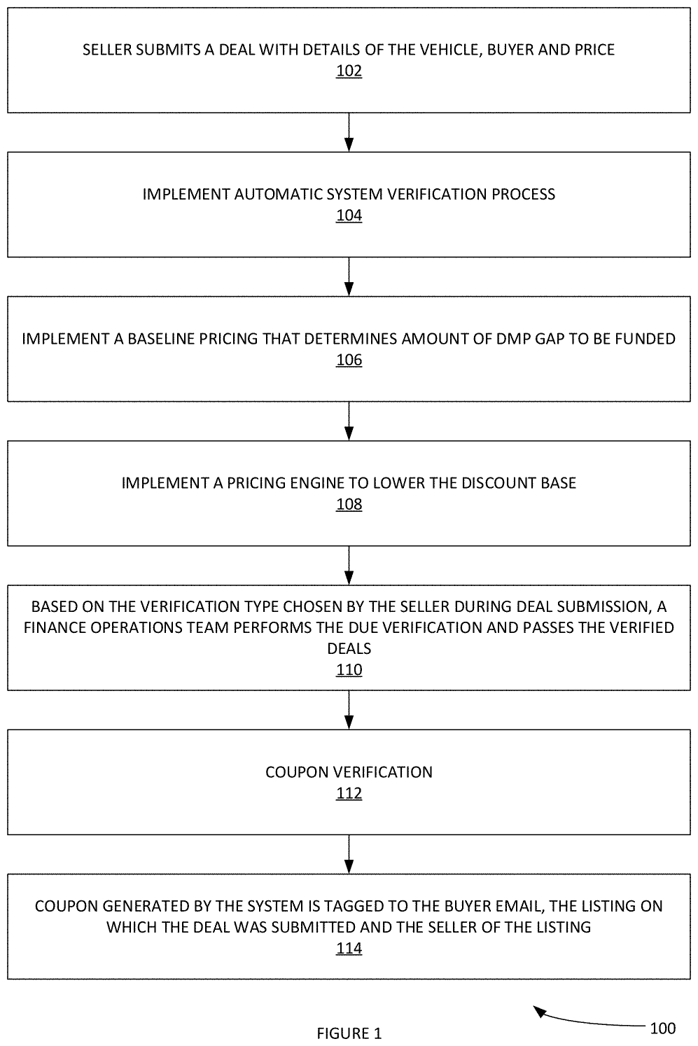

FIG. 1 illustrates an example process 100 for implementing an automated deals evaluation and management platform, according to some embodiments. In step 102, a seller submits a deal with details of the vehicle, buyer and price. The details can include information being submitted by the dealer. This information can include, inter alia: make, model, year and trim of the vehicle; regular selling price of the vehicle; seller asking price (e.g. total payout value); buyer offer price; DMP GAP (e.g. the difference between the seller asking price and the buyer offer price); online vehicle marketplace account details of the vehicle; preferred type of verification (e.g. call/buyer verification, etc.); and the like.

In step 104, the submitted deal is communicated into an automatic system verification process to satisfy a specified set of qualifications. Step 104 can implement process 200.

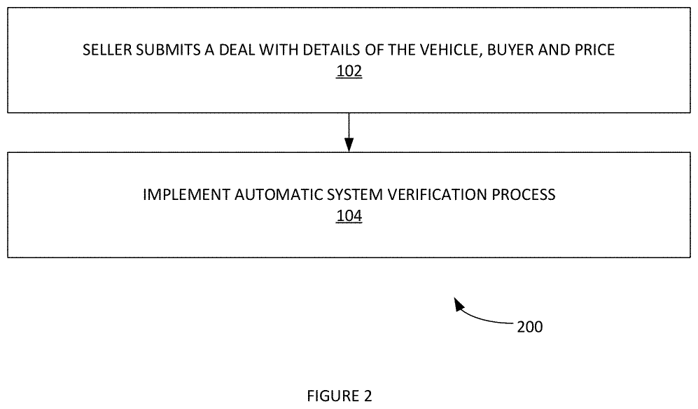

FIG. 2 illustrates an example process 200 for satisfying a specified set of qualifications, according to some embodiments. In step 202, qualifications are grouped into a bucket and categorized as profiles. In step 204, a profile can be defined by location and vehicle category. For example, A Premium/Super Car Delhi can be a profile and the values set against the parameters will be different for different profiles.

A listing of parameters for different profiles is now provided. A Seller Qualification parameter can be provided. Seller qualifications can include, inter alia: allowed only for new sellers; T and C acceptance; minimum number of listings; maximum number of orders; TRS; maximum allowed GMV LTD; Active since (e.g. number of days); minimum seller rating; minimum percentage of positive reviews; maximum allowed percentage cancellation; maximum allowed percentage disputed orders; maximum allowed DMP LTD; verified seller; minimum seller rating score; return policy; minimum required storefront images; CAM mapping; maximum DFC cap per seller per month; maximum allowed net benefit per seller per month; maximum allowed LTD net benefit per seller; maximum allowed accepted deals per seller per month; maximum allowed average age of non DCT; premium pro-seller paid; etc.

An example listings qualification parameter can include, inter alia; FCTS; minimum number of images per listing; video upload; listing age (e.g. Minimum number of days); maximum percentage variation with OBV; percentage variation with orders (high); percentage variation with orders (mean); percentage variation with orders (median); percentage variation with orders (low); percentage variation with listings (high); percentage variation with listings (mean); percentage variation with listings (median); percentage variation with listings (low); seller declaration; maximum allowed vehicle mileage; minimum required seller funded coupon percentage; maximum transactions per vehicle; minimum time between transactions (in days); etc.

An example geography qualification parameter can include, inter alia; cities, etc. An example applicable category qualification can include, inter alia: vehicle; etc. An example type buyer qualification can include, inter alia: buyer photo identity; address proof; phone number; email id; first time user; etc. An example post transaction qualification parameter can include, inter alia: payment after RC transfer; promotion for RC transfer case; promotion for non-RC transfer case; etc.

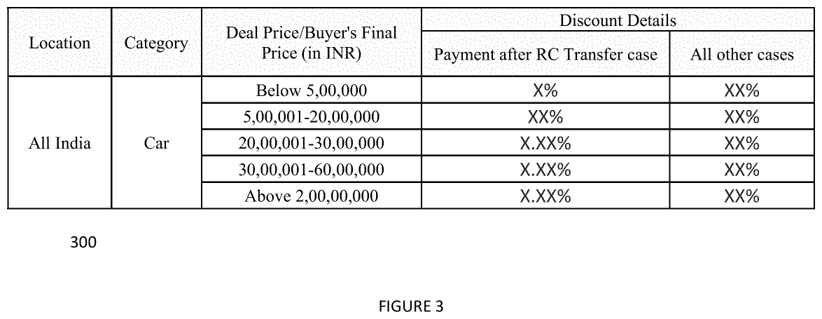

Returning to process 100, in step 106, the deals can either be verified/accepted or rejected by the system based on satisfying the eligibility criteria defined under the respective profiles. Once the deal is accepted post the eligibility criteria check, the deal goes through a baseline pricing which decides how much of the asked DMP gap would be funded by the online vehicle sales platform. This can be the maximum allowed discount. The discount is defined and configurable in the system. In this way, a baseline discount can be defined. FIG. 3 illustrates an example table 300 for implementing baseline pricing, according to some embodiments.

In step 108, once the maximum discount is defined by the automated deals evaluation and management platform using a pricing engine. The pricing engine determines the discount base on the following line items, inter alia: platform adoption considerations such as DMP benefits received (these can include, inter alia: percentage listings with listing certification package; percentage deal requests rejected by the online vehicle sales platform; average listing age criteria; etc.); seller score; pricing score (e.g. seller funded coupon as a percentage of regular selling price); seller SLA (e.g. total cancellations, seller penalty orders as a percentage of total orders, etc.); trade velocity; time to sell; listing conversion; seller engagement (e.g. as a number of times of upload of listings; number of times of update of listings number of sessions, etc.).

In step 110, based on the verification type chosen by the seller during deal submission, process 100 can perform the due verification and pass the verified deals. In one example, this can be implemented by a financial operations team.

In step 112, the coupon verification is implemented. For example, a finance operations team approves the coupon generated by the system. The finance operations team can approve or reject the coupon generated by the system. The finance operations team can also decrease the value of the coupon beyond the value thrown out by the system.

In step 114, the coupon generated by the system is tagged to the buyer email, the listing on which the deal was submitted and the seller of the listing. Once a deal is approved in the system, the listing cannot be bought on the online vehicle sales platform by any other user.

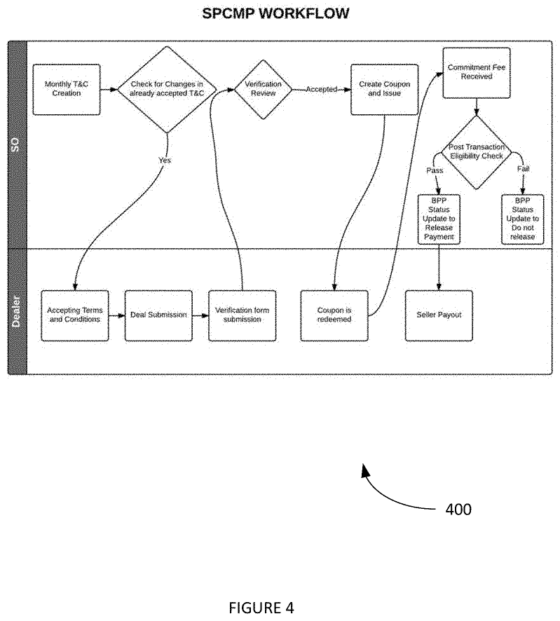

FIG. 4 illustrates an example process 400 for implementing an automated deals evaluation and management platform, according to some embodiments. Process 400 can be used to implement process 100.

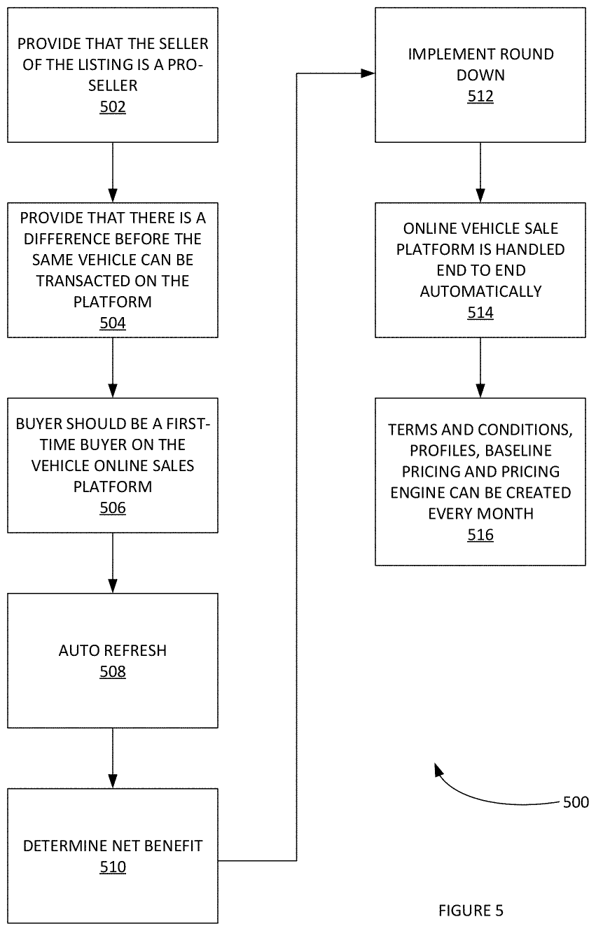

FIG. 5 illustrates an example rules process 500, according to some embodiments. In step 502, process 500 can provide that the seller of the listing is a pro-seller. Else the deal will get rejected. In step 504, process 500 can provide that, for four wheelers, there should be a difference of 365 days before the same vehicle can be transacted on the online vehicle sales platform and for two wheelers the difference should be 180 days minimum. Also, one vehicle cannot be transacted more than twice. The primary key to check these conditions is the registration number of the vehicle. In step 506, the buyer should be a first-time buyer on the vehicle online sales platform. If the buyer has already transacted on the vehicle online sales platform, the deal can be rejected.

In step 508, auto refresh can be implemented. Each coupon generated can be valid for a period of 15 days. Post 15 days, these coupons go through an auto refresh cycle and a 10% of net benefit to the seller is decreased. This can occur for five times and post 90 days of deal submission the coupon becomes invalid. In step 510, the following formula is implemented: Net Benefit=(Droom Funded Coupon Value−(Selling Service Fee+GST)).

In step 512, a round down is implemented. A round down logic is implemented in the system which rounds down the coupon value generated by the system. This is the logic for round down is provided in FIG. 6, according to some embodiments.

Returning to process 500, in step 514, the coupon generated cannot be edited manually. The online vehicle sale platform is handled end to end automatically. In step 516, the terms and conditions, profiles, baseline pricing and pricing engine can be created every month. If not, the last created values will be used by the system to process the deals.

### Example Use Case

An example use case is now discussed. In this example, a Dealer submits a deal onto the SPCMP platform for a Honda city 1.5 SMT, 2010 (MMTY). The Selling Price at 3.25 Lacs INR. The Buyer asking Price at 3 Lacs. The GAP equal to 25,000 INR. The Seller then asks the online vehicle sales platform to help bridge the GAP. Once the above deal is submitted, the deal is qualified on the basis of parameters mentioned below:

Seller Qualification

Allowed only for new sellers Yes

T&C Acceptance Yes

Minimum Number of Listings 7

Maximum Number of Orders 21

TRS Yes

Active Since (Number of Days): 3

Minimum Seller Rating: 5

Minimum % of positive reviews: 70

Verified Seller: Yes

Minimum Seller Rating Score: 5

Return Policy: Yes

Minimum required storefront images: 4

Cam Mapping: Yes

Premium Pro-Seller Paid: Yes

Listing Qualification

FCTS: 8

Minimum Number of images per listing: 5

Video Upload: Yes

Listing Age (Minimum Number of days): 2 days

Maximum Percentage Variation with OBV: 4%

Seller Declaration: Yes

Maximum allowed vehicle mileage: 60,000 kms

Maximum Transactions Per Vehicle: 360 days

Minimum Time Between Transactions (In Days): 360 days

Geography Qualification

Cities Applicable: Yes

Category Qualification

Vehicle Type: Car Yes

Buyer Qualification

Buyer Photo Identity: Aadhar

Address Proof: Yes

Phone Number: Yes

Email ID: Yes

First Time User: Yes

The Deal now stands Qualified for availing discount through SPCMP

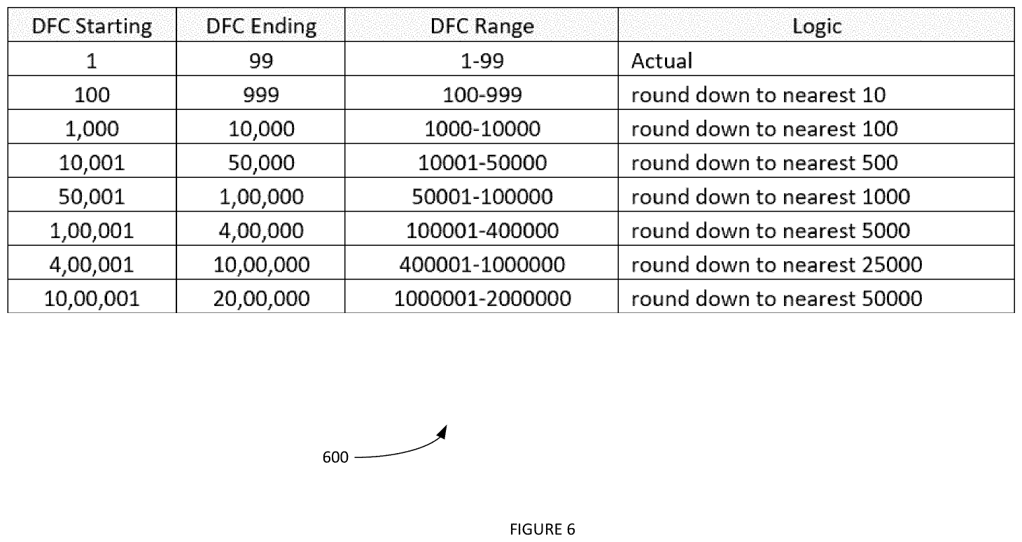

FIG. 7 illustrates an example table 700 for the qualified deal is now subjected to the first SPCMP engine, which assigns a base coupon value to the deal, according to some embodiments. For the listing of the present example, (the selling price is between 0 to 5,00,000 [symbol] ) and location is Delhi and category is Car, therefore the coupon value=0.041×3,00,000 (Coupon discount percentage*Buyer asking price)=12,300 [symbol] .

The Deal Now is subjected to pricing engine, where-as-per the seller behavior and listing quality the coupon value is decreased. This information is provided in Appendix B.

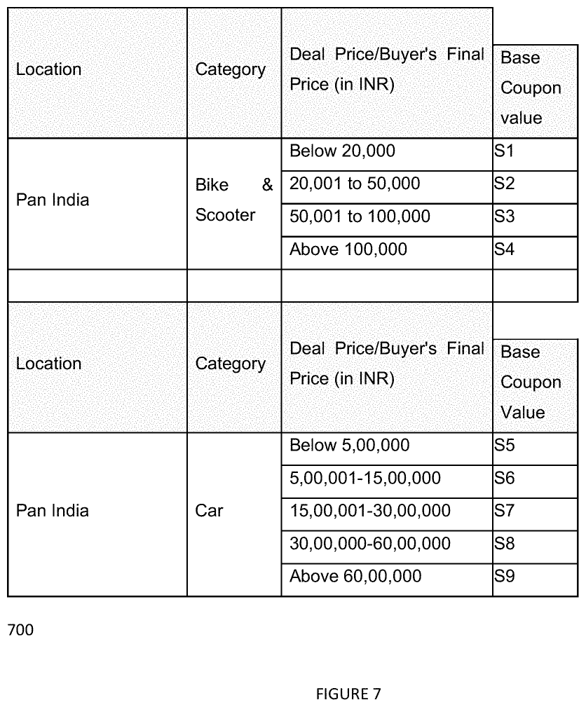

After passing out from the Pricing engine the Coupon value is decreased to 8956 from 12,300. Finally, the coupon is subjected to a third engine called Blackbox maximum Engine, which decides the maximum coupon value, a listing from a particular location, selling price and condition can have. FIG. 8 illustrates the case, as per the engine, the maximum value for the coupon. The coupon is =9485.5 (e.g. auto calculated on basis of algorithms). As per the engine the coupon cannot be greater than 9485.5, thus the deal is assigned a coupon value of 8956 [symbol] as discount, which is less than 9485.5.7. Lastly, the coupon undergoes a roundoff and the coupon value finally assigned to the deal is 8900 [symbol] . A Buyer will get a Coupon discount of 8900 [symbol] if he plans to buy the for a Honda city 1.5 SMT, 2010 from the seller through the online vehicle sales platform.

Additional Example Computer Architecture and Systems

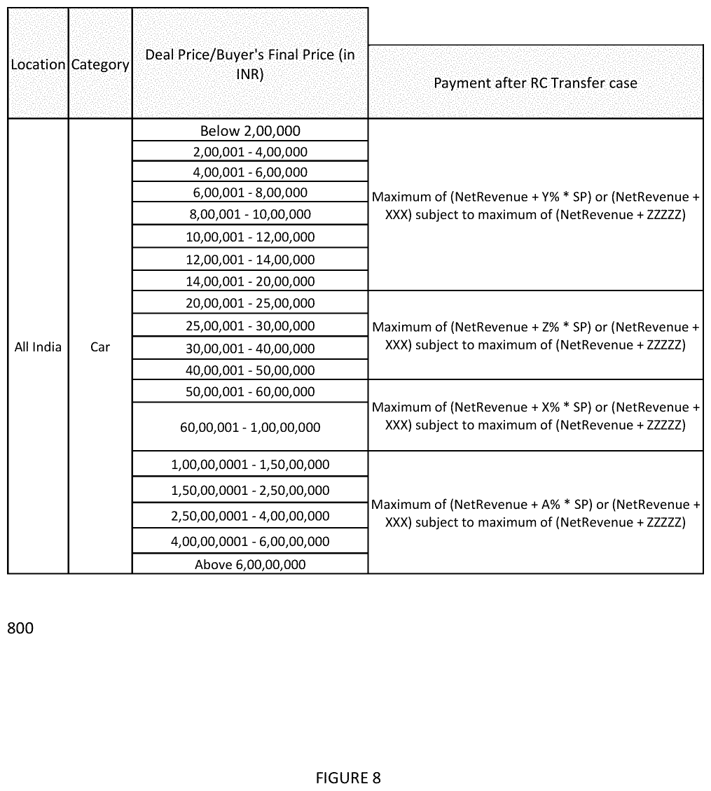

FIG. 9 depicts an exemplary computing system 900 that can be configured to perform any one of the processes provided herein. In this context, computing system 900 may include, for example, a processor, memory, storage, and I/O devices (e.g., monitor, keyboard, disk drive, Internet connection, etc.). However, computing system 900 may include circuitry or other specialized hardware for carrying out some or all aspects of the processes. In some operational settings, computing system 900 may be configured as a system that includes one or more units, each of which is configured to carry out some aspects of the processes either in software, hardware, or some combination thereof.

FIG. 9 depicts computing system 900 with a number of components that may be used to perform any of the processes described herein. The main system 902 includes a motherboard 904 having an I/O section 906, one or more central processing units (CPU) 908, and a memory section 910, which may have a flash memory card 912 related to it. The I/O section 906 can be connected to a display 914, a keyboard and/or other user input (not shown), a disk storage unit 916, and a media drive unit 918. The media drive unit 918 can read/write a computer-readable medium 920, which can contain programs 922 and/or data. Computing system 900 can include a web browser. Moreover, it is noted that computing system 900 can be configured to include additional systems in order to fulfill various functionalities. Computing system 900 can communicate with other computing devices based on various computer communication protocols such a Wi-Fi, Bluetooth® (and/or other standards for exchanging data over short distances includes those using short-wavelength radio transmissions), USB, Ethernet, cellular, an ultrasonic local area communication protocol, etc.

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it can be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

What is claimed:

1. A method for implementing a implementing an automated deals evaluation and management platform comprising:
determining that a seller submits a deal with details of the vehicle, buyer and price;
determining that the submitted deal is communicated into an automatic system verification process to satisfy a specified set of qualifications;
determining that the deals are accepted or rejected by the automated deals evaluation and management platform based on satisfying the eligibility criteria defined under the respective profiles;
once the maximum discount is defined by the automated deals evaluation and management platform using a pricing engine, determining with the pricing engine the discount base on the following line items;
based on the verification type chosen by the seller during deal submission, performing a due verification and passing the verified deals with a financial operations team;
implementing a coupon verification; and
generating a coupon generated and tagging the coupon to a buyer email and a vehicle listing on which the deal was submitted and the seller of the listing.

2. The method of claim 1, wherein the details of the vehicle, buyer and price comprises information being submitted by the dealer.

3. The method of claim 2, wherein the details of the vehicle, buyer and price comprises a vehicle make.

4. The method of claim 3, wherein the details of the vehicle, buyer and price comprises a vehicle model.

5. The method of claim 4, wherein the details of the vehicle, buyer and price comprises a vehicle year.

6. The method of claim 5, wherein the details of the vehicle, buyer and price comprises a vehicle trim.

7. The method of claim 6, wherein the details of the vehicle, buyer and price comprises a regular selling price of the vehicle.

8. The method of claim 7, wherein the details of the vehicle, buyer and price comprises a seller asking price.

9. The method of claim 8, wherein the details of the vehicle, buyer and price comprises a buyer offer price.

10. The method of claim 9, wherein the details of the vehicle, buyer and price comprises a DMP GAP comprising the difference between the seller asking price and the buyer offer price.

11. The method of claim 10, wherein the details of the vehicle, buyer and price comprises an online vehicle marketplace account details of the vehicle.

12. The method of claim 11, wherein once the deal is accepted post the eligibility criteria check, the deal goes through a baseline pricing which decides an amount of the asked DMP gap is to be funded by the online vehicle sales platform.

13. The method of claim 12, wherein the amount of the asked DMP gap is the maximum allowed discount.

14. The method of claim 13, wherein once a deal is approved in the system, the listing cannot be bought on the online vehicle sales platform by any other user.
